(19) United States
(12) Patent Application Publication
(10) Pub. No.: US 2014/0118891 A1
(43) Pub. Date: May 1, 2014

(54) REMOVABLE BYPASS PLUGS FOR NETWORK INTERFACE DEVICE LINE MODULES

(71) Applicants: Robert Alexander Crane, Keller, NC (US); Christian Shane Duran, Ft. Worth, TX (US); John Austin Keenum, Keller, TX (US); Rodger Alan Tenholder, Saginaw, TX (US)

(72) Inventors: Robert Alexander Crane, Keller, NC (US); Christian Shane Duran, Ft. Worth, TX (US); John Austin Keenum, Keller, TX (US); Rodger Alan Tenholder, Saginaw, TX (US)

(21) Appl. No.: 13/664,998

(22) Filed: Oct. 31, 2012

(51) Int. Cl. H02B 1/26; H01R 13/60

(52) U.S. Cl. 361/657; 439/535

(57) ABSTRACT

A Network Interface Device (NID) line module that includes a module housing configured to receive, in one or more cavities, a removable plug component containing a bridging contact. The line module has a subscriber wire contact connected to a plurality of subscriber wires and a provider wire contact connected to a plurality of provider wires. The bridging contact contacts the subscriber wire contact and the provider wire contact making an electrical connection between the subscriber wire contact and the provider wire contact when the removable plug component is installed in the module housing. When the removable plug component is removed and detached from the one or more cavities on the module housing, the electrical connection between the subscriber wire contact and provider wire contact is broken.

### FIELD

The disclosure relates to universal network interface device line modules that include subscriber contacts and service provider contacts, where removable plug components are used to create or break electrical connections between the subscriber contacts and service provider contacts.

### BACKGROUND

Telephone service is often provided by a telephone company, or provider, to customers of the provider, commonly referred to as subscribers. Each subscriber may purchase more than one separate telephone line or a number of telephone lines may be routed to a multi-unit dwelling, such as an apartment building. Often, the subscriber may be responsible for the proper operation of the telephone equipment and the provider may be responsible for the proper operation of the telephone network up to an interface between the provider wiring and subscriber wiring. The interface between the provider wiring and subscriber wiring may be demarcated by a Network Interface Device (NID) line module that isolates the provider portion of the telephone network and wiring from the subscriber portion of the telephone network and wiring. The isolation created by the line module in the NID may also segregate the responsibility for faults or malfunctions that occur in respective portions of the system.

### SUMMARY

Embodiments disclosed herein include Network Interface Device (NID) line modules that may include removable plug components. The removable plug components disclosed herein can be provided as part of a line module or provided to network service technicians for connection with the line modules. As a non-limiting example, the removable plug components disclosed herein may be used for making an electrical connection between subscriber wiring and provider wiring in a line module.

In this regard, in one embodiment, a line module includes a module housing. A subscriber wire contact and a provider wire contact are located in the module housing and are accessible through one or more cavities that extend into the module housing. The line module includes a removable plug component that is separable from the module housing and includes a bridging contact. In a first configuration, the removable plug component is connected to the module housing and the bridging contact makes an electrical connection between the subscriber wire contact and provider wire contact when the bridging contact is inserted into the one or more cavities on the module housing between and in contact with the subscriber wiring contact and the provider wiring contact. In a second configuration, the removable plug component detaches from the module housing and the electrical connection between the subscriber wire contact and provider wire contact is broken when the bridging contact is removed from the one or more cavities.

In another embodiment, a method of creating an electrical connection between a subscriber wire contact and provider wire contact of a line module is provided. The method includes connecting a subscriber wire to a subscriber wire contact at a location within a module housing of the line module, and connecting a provider wire to a provider wire contact at a location within the module housing of the line module. An electrical connection is made between the subscriber wire contact and the provider wire contact by inserting a removable plug component containing a bridging contact into one or more cavities extending into the module housing between and in contact with the subscriber wiring contact and the provider wiring contact. The electrical connection between the subscriber wire contact and provider wire contact can be broken by removing the bridging contact from the one or more cavities and detaching the removable plug component from the module housing.

In another embodiment, a line module includes a module housing having a test jack area, a subscriber termination point area, and a bypass plug area on a face. The line module also includes a removable plug component containing a bridging contact. The bypass plug area includes one or more cavities to receive the bridging contact and the removable plug component covers a surface area on the face that is less than the test jack area, the subscriber termination point area, and the bypass plug area on the face with the bridging contact received by the one or more cavities.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

FIG. 1 is a perspective view of an embodiment of a Network Interface Device (NID) line module including an embodiment of a module housing and an embodiment of a removable plug component;

FIG. 2 illustrates the line module of FIG. 1 with the removable plug component removed from the module housing;

FIG. 3 is a schematic top view of the module housing of FIG. 2;

FIG. 4 is a diagrammatic top view of a top face of the module housing of FIG. 3 including a subscriber termination point area, a bypass plug area, and a test jack area;

FIG. 5 is a side view of the removable plug component of FIG. 1 in isolation;

FIG. 6 is a perspective view of the removable plug component shown in FIG. 5;

FIG. 7 is a bottom view of the removable plug component shown in FIG. 5;

FIG. 8 is a perspective view of another embodiment of a removable plug component;

FIG. 9 is a bottom view of the removable plug component of FIG. 8;

FIG. 10 is a perspective view of another embodiment of a removable plug component;

FIG. 11 is a bottom view of the removable plug component of FIG. 10;

FIG. 12 is a cross-section view of the line module of FIG. 1 with the removable plug component including a bridging contact installed;

FIG. 13 is an electrical schematic illustrating a removable plug component with a bridging contact creating an electrical connection between a subscriber wire contact and a provider wire contact; and

FIG. 14 illustrates a method of creating an electrical connection between the subscriber wire contact and provider wire contact of FIG. 13.

### DETAILED DESCRIPTION

Embodiments disclosed herein generally relate to Network Interface Device (NID) line modules that include a module housing that receives both a plurality of provider wires and a plurality of subscriber wires and serves as a junction for connecting the plurality of provider wires to the plurality of subscriber wires. A removable plug component may be connected to the module housing by inserting a bridging contact through cavities extending into the module housing between and in contact with the subscriber wiring contact and the provider wiring contact. In this way, the bridging contact provides a connection between a provider wire contact connected to the plurality of provider wires and a subscriber wire contact connected to the plurality of subscriber wires. As will be described in greater detail below, the removable plug component covers only a limited portion of the module housing, which can provide more convenient access to subscriber termination points accessible on the module housing.

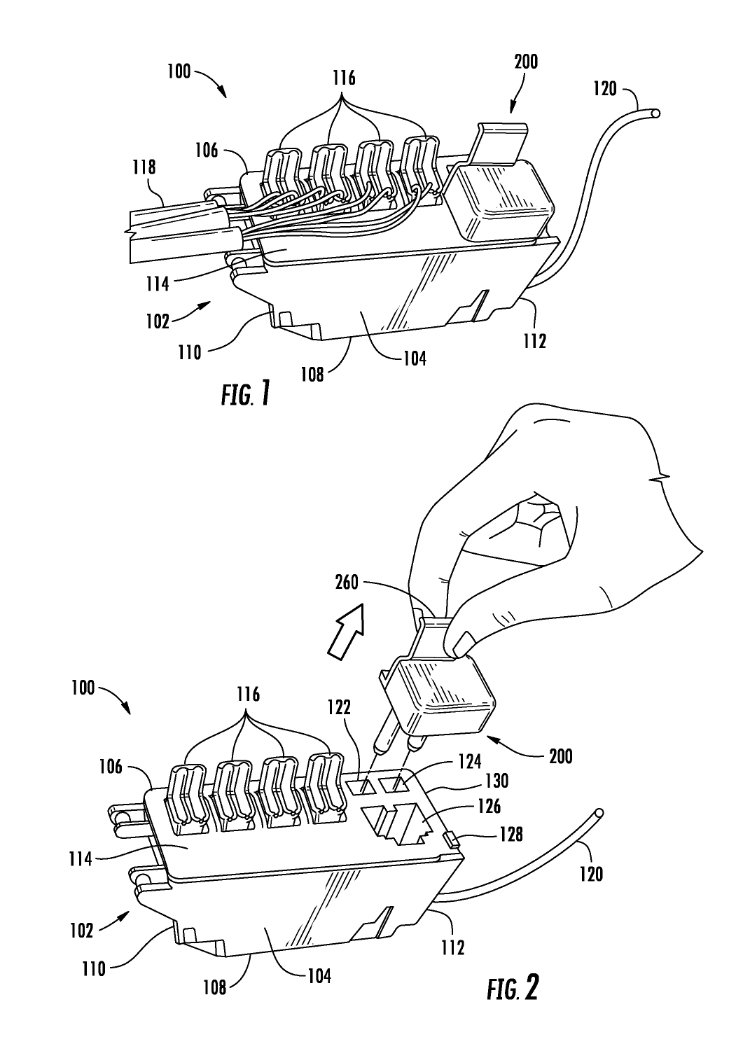

Referring to FIG. 1, a line module 100 may include a module housing 102 and may also include a removable plug component 200 that is separable from the module housing 102. The module housing 102 may be of any suitable shape, such as the box-like shape of FIG. 1, including a front face 104, back face 106, bottom face 108, side faces 110 and 112, and top face 114. One or more subscriber termination points 116 that receive a plurality of subscriber wires 118 may be located on any face of the line module 100, such as the top face 114 of the module housing 102 in FIG. 1.

The module housing 102 includes the bottom face 108 and the front, back, and side faces, collectively referred to as perimeter faces, 104, 106, 110, and 112 that define an interior cavity 614 for receiving terminating equipment and wiring connections housed within the line module 100 (see FIG. 12). The perimeter faces 104, 106, 110, and 112 preferably extend upwards from the bottom face 108 and form the module housing 102. The line module 100 may act as a demarcation point between the subscriber wiring 118 and provider wiring 120.

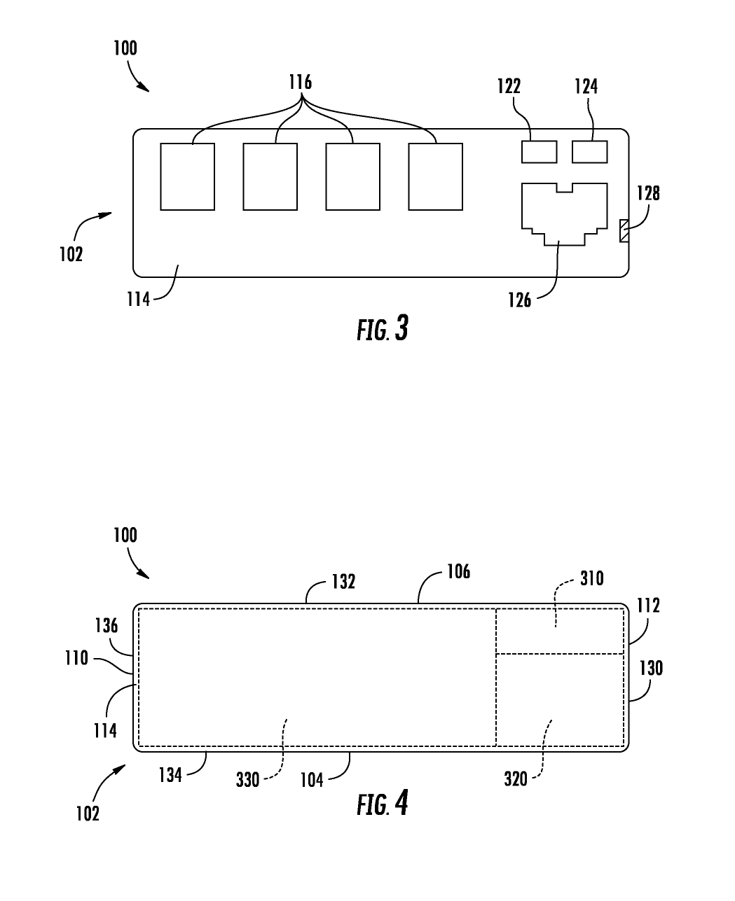

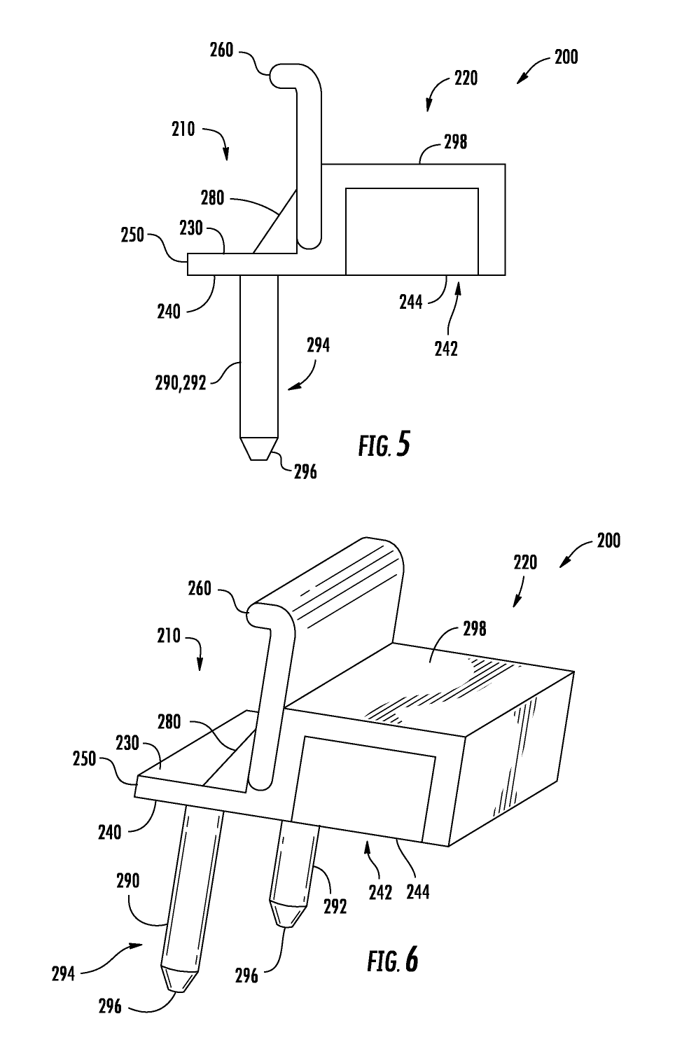

Referring to FIG. 2, the line module 100 is shown with the removable plug component 200 removed and detached from the module housing 102 manually. On the top face 114 of the module housing 102, one or more cavities 122 and 124 extend inwardly into the module housing 102. The one or more cavities 122 and 124 may be located at any face of the module housing 102, such as the top face 114 of the module housing 102 as shown in FIG. 2. The one or more cavities 122 and 124 provide access to at least one subscriber wire contact 610 and at least one provider wire contact 612 (see FIG. 12). A test jack 126 may be located on the module housing 102 at the top face 114. The test jack 126 can be in the form of any telecommunications jack, such as a RJ45 jack, and can also be in the form of a RJ11 jack as shown in FIG. 2. The one or more cavities 122 and 124 may receive the removable plug component 200 and retain the removable plug component 200 with a detent or interference fit when the removable plug component 200 is installed in the module housing 102. When not installed, the removable plug component 200 can be completely detached and separated from the module housing 102 in a single step by a technician by grasping a tab 260 on top of the removable plug component 200 (see FIG. 5). An electrical connection between the subscriber wire contact 610 and provider wire contact 612 (see FIG. 12) may be made by manually installing the removable plug component 200 in the module housing 102. A locking tab 128 may protrude from the top face 114 of the module housing 102 at the junction of the top face 114 and side face 112. The locking tab 128 may be located anywhere extending upward from the top face 114 but is generally located near the edge 130 and test jack 126 as shown in FIG. 3. The locking tab 128 can be used to lock the removable plug component 200 in place on the module housing 102.

Referring to FIG. 3, the top face 114 of the module housing 102 is shown. The top face 114 may include the one or more subscriber termination points 116, as well as the one or more cavities 122 and 124. The test jack 126 may also be included in different forms, such as an RJ11 or RJ45 jack.

Referring to FIG. 4, the top face 114 of the module housing 102 is divided into three sections 310, 320, and 330. Section 310 is a bypass area, which encompasses the area on the top face 114 of the module housing 102 that includes the one or more cavities 122 and 124 shown in FIG. 3. Section 320 is a test jack area, located on the top face 114 and encompassing the test jack 126 shown in FIG. 3. Section 330 is a subscriber termination point area, located on the top face 114 and encompassing the subscriber termination points 116 shown in FIG. 3. The bypass plug area 310 extends from an edge 132 formed by the back face 106 and the top face 114 to the test jack area 320. The bypass plug area 310 extends in the transverse direction from the edge 130 formed by the side face 112 and the top face 114 to the subscriber termination point area 330. The test jack area 320 extends from the edge 134 formed by the front face 104 and the top face 114 to the bypass plug area 310. The test jack area extends in the transverse direction from the edge 130 formed by the side face 112 and top face 114 to the subscriber termination point area 330. The subscriber termination point area 330 encompasses the subscriber termination points 116 and extends from the edge 134 formed by the top face 114 and the front face 104 to the edge 132 formed by the top face 114 and the back face 106. The subscriber termination point area 330 extends in the transverse direction from the edge 136 formed by the side face 110 and top face 114 to the bypass plug area 310 and the test jack area 320.

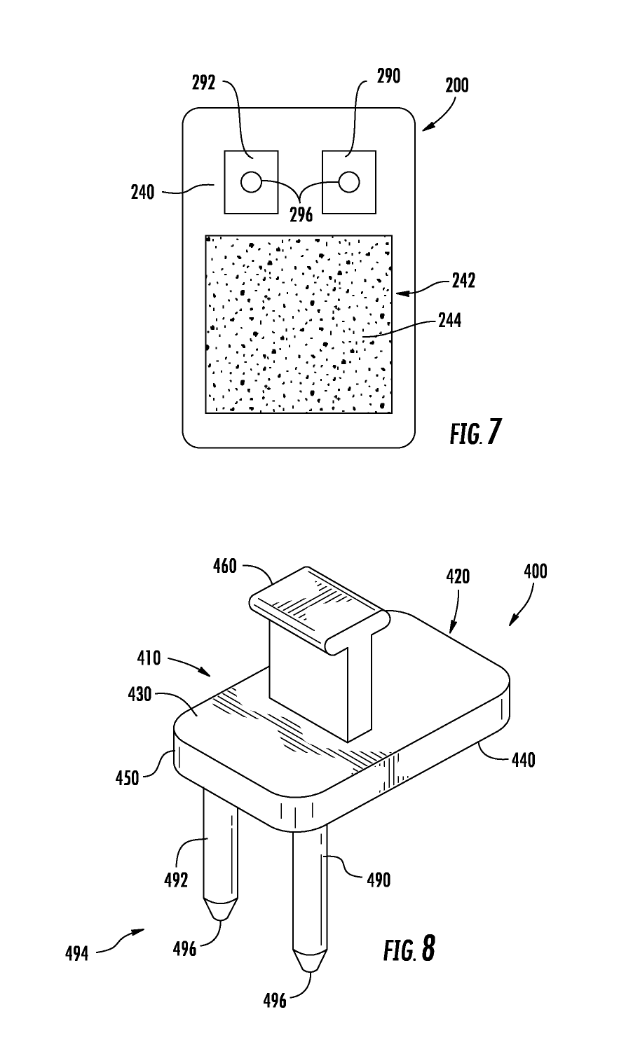

Referring to FIG. 5, the removable plug component 200 is displayed in isolation. The removable plug component 200 has a first portion 210 that covers the bypass plug area 310 on the module housing 102 and a second portion 220 that covers the test jack area 320 on the module housing 102. The removable plug component 200 has a first top surface 230, a bottom surface 240, a thickness 250, and a raised second top surface 298. A tab 260 protrudes upwardly from the first top surface 230 and above the raised second top surface 298 of the removable plug component 200 that is configured to be grasped manually and used to insert or remove the removable plug component 200 from the module housing 102. The tab 260 is located between the first portion 210 and second portion 220 of the removable plug component 200 and may have any length from the first top surface 230 of the removable plug component 200 that facilitates grasping by the technician. Support ribs 280 are placed at the base of the tab 260 and the first top surface 230 of the removable plug component 200. The support ribs 280 can provide additional structural support to the tab 260 to reduce the possibility of breaking the tab 260 and to provide rigidity to the tab 260 when grasped by the technician. Two protrusions 290 and 292 of a length sufficient to insert into the one or more cavities 122 and 124 are located on the module housing 102 and extend from the bottom surface 240 of the first portion 210 of the removable plug component 200. The two protrusions 290 and 292 form part of a bridging contact 294 that can be exposed on any point along the two protrusions 290 and 292, such as the bottom 296 as shown in FIG. 5. The bridging contact 294 is made of any conductive element, such as, without limitation, aluminum or copper. In this way, the bridging contact 294 positions between and is in contact with the subscriber wiring contact and the provider wiring contact, thereby making an electrical connection between the subscriber wiring contact and the provider wiring contact. A recess 242 exists in this embodiment of the removable plug component 200, in which a sealing component 244 is inserted (see FIG. 7). The removable plug component 200 covers the bypass plug area 310 and test jack area 320 on the module housing 102, leaving the subscriber termination point area 330 uncovered and easily accessible by technicians. The removable plug component 200 in this embodiment is formed of molded plastic, such as, without limitation, polyvinyl chloride or polyethylene, polypropylene through a process such as injection molding.

FIG. 6 shows a perspective view of the removable plug component 200 shown in FIG. 5. Because of the recess 242, the removable plug component 200 has a first top surface 230 on one side of the tab 260 and a raised second top surface 298 on the other side of the tab 260 to accommodate the sealing component 244.

FIG. 7 shows the bottom surface 240 of the removable plug component 200. The bottom surface 240 remains flat other than the two protrusions 290 and 292. The sealing component 244 is visible in the view and can be made of foam, rubber, or any other sealing material and provides protection from the environment.

Referring to FIG. 8, another embodiment of a removable plug component 400 is shown in perspective view. This embodiment is divided into a first portion 410 that covers the bypass plug area 310 on the module housing 102 and a second portion 420 that covers the test jack area 320 on the module housing 102. In between the first portion 410 and second portion 420, on the top surface 430, a bottom surface 440 and a thickness 450. A tab 460 configured to be grasped manually extends a length upwards from the removable plug component 400, allowing the technician to grasp the tab 460. The tab 460 can take different forms, such as the rounded T-shape shown in FIG. 8. Two protrusions 490 and 492 extend outwards from the bottom surface 440 of the first portion 410 of the removable plug component 400. The two protrusions 490 and 492 form part of a bridging contact 494, with the bridging contact 494 exposed anywhere along the protrusions, such as at the bottom 496. The protrusions 490 and 492 are of a length sufficient to be inserted fully into the one or more cavities 122 and 124 located on the module housing 102. The top surface 430 of the removable plug component 400 is flat and can be modified to include a rubber seal around the perimeter of the removable plug component 400 to protect against environmental elements.

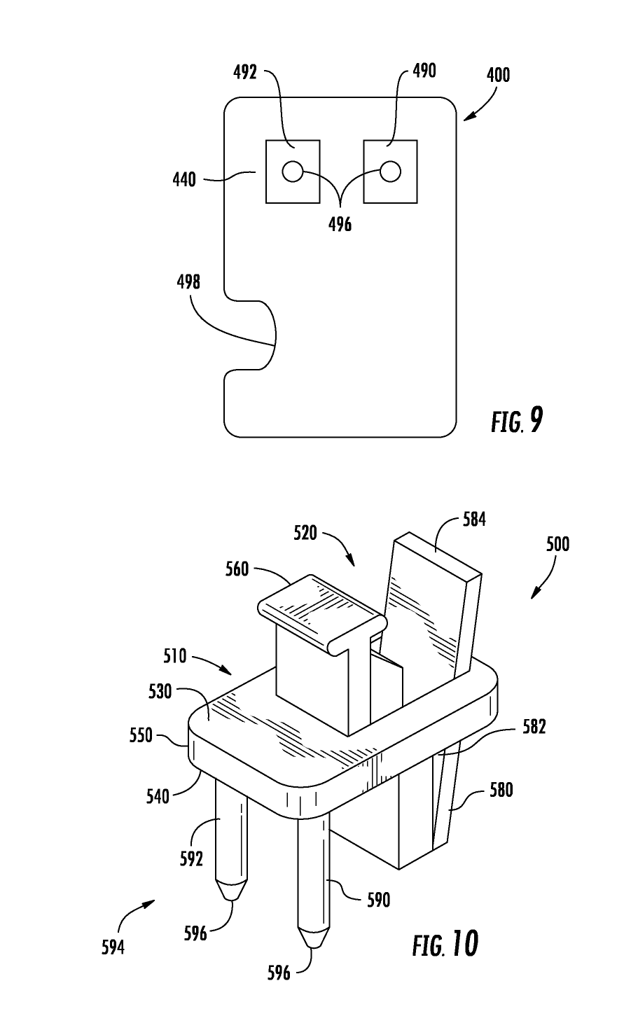

FIG. 9 illustrates the bottom surface 440 of the removable plug component 400 shown in FIG. 8. The bottom surface 440 of removable plug component 400 remains flat other than the two protrusions 490 and 492 extending out of the bottom surface 440 from the first portion 410 of the removable plug component 400. A notch 498 is formed in one side of the removable plug component 400, allowing this embodiment to avoid the locking tab 128 on the line module 100 (see FIG. 2). The notch 498 can be any shape or size, including square and rounded.

FIG. 10 is a perspective view of another embodiment of a removable plug component 500. The removable plug component 500 has two portions: a first portion 510 that covers the bypass plug area 310 on the module housing 102 and a second portion 520 that covers the test jack area 320 on the module housing 102. This embodiment has a top surface 530 that is flat at the first portion 510 and has a RJ11 style releasing mechanism 584 at top surface 530 of the second portion 520. A tab 560 extends upwardly a length away from the top surface 530 of the removable plug component 500, and is centered between the first portion 510 and second portion 520. The tab 560 is shaped as to facilitate grasping by the technician. The removable plug component 500 has a thickness 550 and a bottom surface 540. From the bottom surface 540 of the first portion 510 of the removable plug component 500 extend two protrusions 590 and 592 that contain a bridging contact 594. The bridging contact 594 is exposed anywhere along the protrusion, such as at the bottom of each protrusion 596 as shown in FIG. 10. The bottom surface 540 of the second portion 520 has a RJ11 plug 580 and a latching component 582 to allow the removable plug component 500 to be retained in the line module 100 with a RJ11 plug fit.

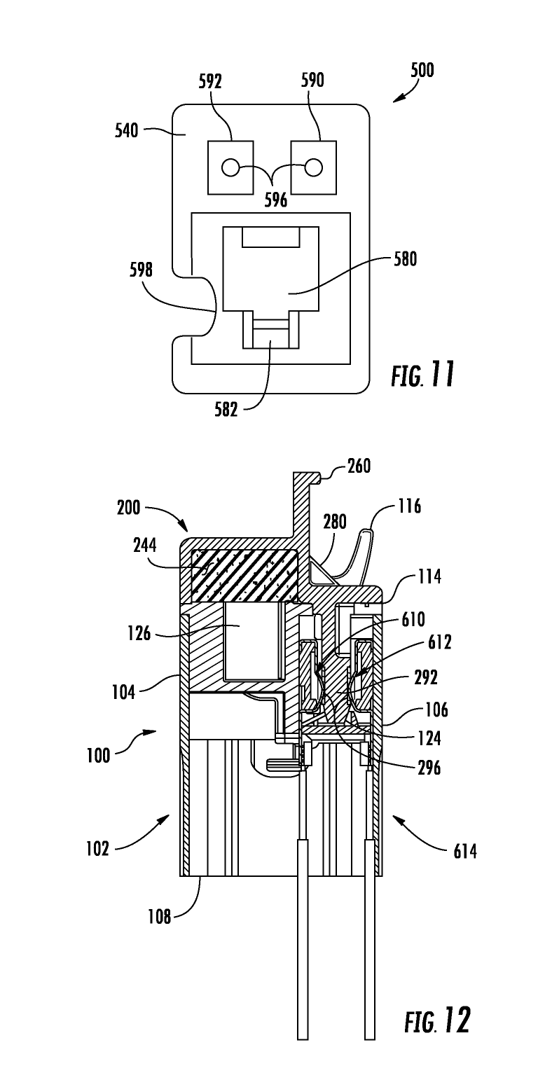

FIG. 11 shows the bottom view the removable plug component 500 shown in FIG. 10. The removable plug component 500 has two protrusions 590 and 592 that extend away from the bottom surface 540 of the removable plug component 500. A RJ11 plug 580 extends away from the bottom surface 540 of the removable plug component 500 with a latching component 582. When the removable plug component 500 is inserted into the module housing 102, the RJ11 plug 580 mates with the test jack 126 on the top face 114 of the module housing 102, securing the removable plug component 500 in place. A notch 598 is removed from the side of the removable plug component 500 to allow compatibility with the line module 100.

FIG. 12 shows a cross-section view of the line module 100 with the exemplary removable plug component 200 installed. The sealing component 244 covers the test jack 126 on the top face 114 of the module housing 102. The test jack 126 extends into the module housing 102. The support rib 280 is visible on the removable plug component 200 and the subscriber termination points 116 are visible behind the removable plug component 200. A subscriber wire contact 610 and provider wire contact 612 may be positioned anywhere along the one or more cavities 122 and 124. Cavity 124 is shown in FIG. 12 with the subscriber wire contact 610 and provider wire contact 612 positioned across from each other near the bottom of the cavity 124. A protrusion 292 extending from the removable plug component 200 fits into the cavity 124. In this way, the exposed bridging contact 296 positions between and contacts the subscriber wire contact 610 and provider wire contact 612, thereby making an electrical connection between the subscriber wire contact 610 and provider wire contact 612 when the removable plug component 200 is installed in the module housing 102. When the removable plug component 200 and bridging contact 294 is removed and detached from the module housing 102, the bridging contact 294 is removed from between the subscriber wire contact 610 and provider wire contact 612 and the electrical connection between the subscriber wire contact 610 and provider wire contact 612 is broken.

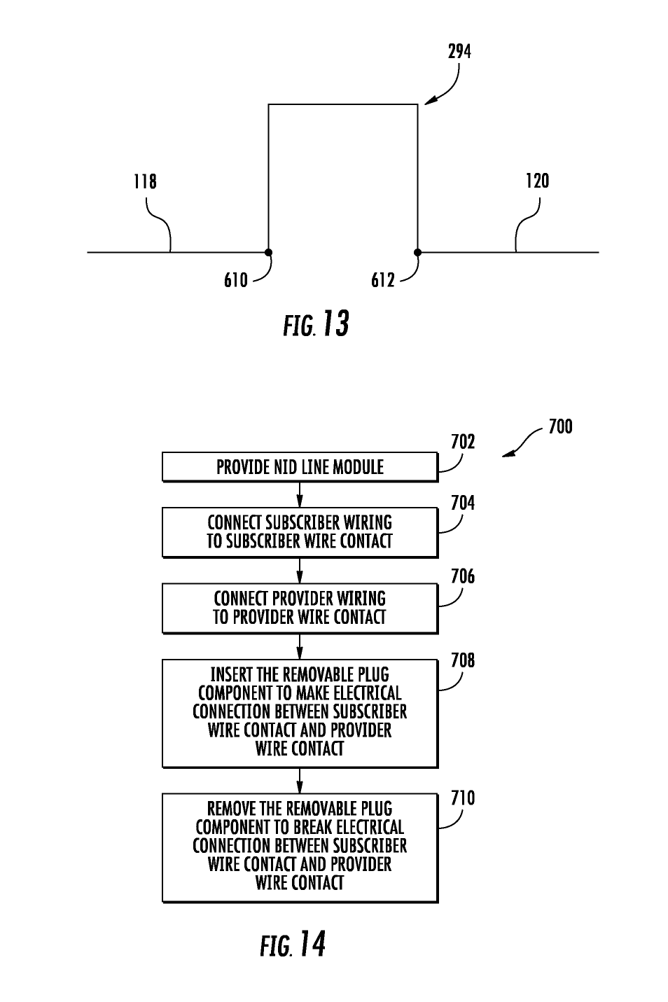

FIG. 13 is an electrical schematic showing the plurality of subscriber wires 118 joined to the plurality of provider wires 120 by the bridging contact 294 contained in the removable plug component 200. The schematic is applicable to the removable plug component 200 when the removable plug component 200 is installed in the module housing 102.

Referring to FIG. 14, a method 700 of creating an electrical connection is illustrated by first providing a line module at step 702. At step 704, the subscriber wiring is connected to a subscriber wire contact, and at step 706, the provider wiring is connected to a provider wire contact. A network technician may then create an electrical connection between the subscriber wire contact and provider wire contact at step 708 by inserting a removable plug component containing a bridging contact into the one or more cavities on the module housing. The network technician may then break the electrical connection between the subscriber wire contact and provider wire contact at step 710 by removing the bridging contact and detaching the removable plug component from the module housing.

The above-described line module 100 and removable plug components allow unimpeded access to the subscriber termination points 116 and subscriber termination point area 330 on the top face 114 of the line module 100. By leaving the subscriber termination points 116 uncovered, a network technician has flexibility in using smaller gauge wiring when connecting the line module 100. Additionally, the removable plug component 200 can be removed and completely detached in one sequence, allowing easy access to the bypass plug area 310 and test jack area 320 in a single step.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

1. A Network Interface Device (NID) line module comprising:
a module housing;
a subscriber wire contact located in the module housing and being accessible through one or more cavities extending into the module housing;
a provider wire contact located in the module housing and being accessible through the one or more cavities extending into the module housing; and
a removable plug component separable from the module housing including a bridging contact;
wherein in a first configuration the removable plug component connects to the module housing and the bridging contact contacts the subscriber wire contact and the provider wire contact making an electrical connection between the subscriber wire contact and the provider wire contact when the bridging contact is inserted into the one or more cavities; and
wherein in a second configuration the removable plug component detaches from the module housing and the electrical connection is broken when the bridging contact is removed from the one or more cavities.

2. The line module of claim 1, wherein the bridging contact positions between the subscriber wire contact and the provider wire contact in the first configuration.

3. The line module of claim 1 further comprising one or more subscriber termination points accessible along a subscriber termination point area at a face of the module housing.

4. The line module of claim 3, wherein the one or more cavities are located at a bypass plug area on the face.

5. The line module of claim 4, wherein a telecommunications jack is located at a test jack area on the face.

6. The line module of claim 5, wherein the removable plug component covers only the bypass plug area and test jack area on the face.

7. The line module of claim 5, wherein a surface area covered by the removable plug component on the face is less than the test jack area, bypass plug area and subscriber termination point area combined.

8. The line module of claim 1, wherein the removable plug component is retained in the one or more cavities by a detent fit.

9. The line module of claim 1, wherein the removable plug component is retained in the one or more cavities by an interference fit.

10. The line module of claim 1, wherein the removable plug component is retained in the one or more cavities by a latch mechanism.

11. The line module of claim 1, wherein a tab protrudes from the top of the removable plug component configured to be grasped manually.

12. The line module of claim 1, wherein a sealing component seals around the one or more cavities.

13. A method of creating an electrical connection between a subscriber wire contact and provider wire contact of a Network Interface Device (NID) line module, comprising:
connecting a subscriber wire to the subscriber wire contact at a location within a module housing of the line module;
connecting a provider wire to the provider wire contact at a location within the module housing of the line module;
making an electrical connection between the subscriber wire contact and the provider wire contact by inserting a removable plug component containing a bridging contact into one or more cavities extending into the module housing; and
breaking the electrical connection between the subscriber wire contact and provider wire contact by removing the bridging contact from the one or more cavities and detaching the removable plug component from the module housing.

14. The method in accordance with claim 13, wherein the inserting a removable plug component containing a bridging contact positions the bridging contact between the subscriber wire contact and the provider wire contact such that the bridging contact contacts the subscriber wire contact and the provider wire contact.

15. The method in accordance with claim 13, wherein the line module further comprises one or more subscriber termination points accessible along a subscriber termination point area at a face of the module housing.

16. The method in accordance with claim 15, wherein the one or more cavities are located at a bypass plug area on the face.

17. The method in accordance with claim 16, wherein a telecommunications jack is located at a test jack area on the face.

18. The method in accordance with claim 16 further comprising covering only the bypass plug area and test jack area.

19. The method in accordance with claim 13 further comprising retaining the removable plug component in the one or more cavities by a detent fit.

20. The method in accordance with claim 13 further comprising retaining the removable plug component in the one or more cavities by an interference fit.

21. The method in accordance with claim 13 further comprising retaining the removable plug component in the one or more cavities by a latch mechanism.

22. The method in accordance with claim 13 further comprising the step of breaking the electrical connection between the subscriber wire contact and provider wire contact by pulling the bridging contact out of the one or more cavities using a tab that protrudes from the top of the removable plug component.

23. The method in accordance with claim 13 further comprising sealing around the one or more cavities using a sealing component.

24. A Network Interface Device (NID) line module, comprising:
a module housing having a test jack area, a subscriber termination point area and a bypass plug area on a face; and
a removable plug component comprising a bridging contact;
wherein the bypass plug area comprises one or more cavities to receive the bridging contact; and
wherein the removable plug component covers a surface area on the face that is less than the test jack area, the subscriber termination point area and the bypass plug area combined on the face with the bridging contact received by the one or more cavities.

25. The line module of claim 24 further comprising one or more subscriber termination points accessible along a subscriber termination point area at a face of the module housing.

26. The line module of claim 24, wherein the removable plug component covers only the test jack area and the bypass plug area located at the face.

27. The line module of claim 24, wherein a telecommunications jack is located at the test jack area on the face.

28. The line module of claim 24, wherein the removable plug component is retained in the one or more cavities by a detent fit.

29. The line module of claim 24, wherein the removable plug component is retained in the one or more cavities by an interference fit.

30. The line module of claim 24, wherein the removable plug component is retained in the one or more cavities by a latch mechanism.

31. The line module of claim 24, wherein a tab protrudes from the top of the removable plug component configured to be grasped manually.

32. The line module of claim 24, wherein a sealing component seals around the one or more cavities.
